(19) United States
(12) Patent Application Publication
(10) Pub. No.: US 2002/0182048 A1
(43) Pub. Date: Dec. 5, 2002

(54) Method and apparatus for extracting and installing heat exchanger bundles

(75) Inventors: Thomas B. Boisture, Baytown, TX (US); David E. Cichon, O-fallon, MO (US); Jeffrey L. Wilson, Winfield, IL (US); Michael J. Uremovich, Manhattan, IL (US)

Correspondence Address: FULBRIGHT & JAWORSKI, LLP, 1301 MCKINNEY, SUITE 5100, HOUSTON, TX, 77010-3095, US

(73) Assignee: Starcon International, Inc., Manhattan, IL

(21) Appl. No.: 10/201,334

(22) Filed: Jul. 23, 2002

Related U.S. Application Data
(63) Continuation-in-part of application No. 09/866,276, filed on May 25, 2001.
Application No. 09/866,276 is a continuation-in-part of application No. 09/851,354, filed on May 8, 2001.
(60) Provisional application No. 60/235,131, filed on Sep. 25, 2000.

(51) Int. Cl. B66F 19/00

(52) U.S. Cl. 414/745.3; 29/726.5

(57) ABSTRACT

An apparatus and a method to remove and install heat exchanger bundles. The apparatus comprises a main frame supporting wheel assemblies. A second frame is vertically displaceable relative to the main frame. A lifting system is provided which elevates the entire unit so that the wheel assemblies are off the ground a minimal distance to ensure stability and then the second frame is elevated the remaining amount to the final elevation of the heat exchanger bundle to be removed or installed. The preferred embodiment includes a horizontally displaceable portion of the second frame for supporting the heat exchanger as it is extracted from the shell side assembly. The unit is self-contained including power means to horizontally displace the frame to affect the displacement of the heat exchanger, lower the second frame relative to the main frame, and then lower the entire unit to the ground. The unit is also powered so that the wheel assemblies which are individually steerable can maneuver the unit into a restricted area.

### CROSS-REFERENCE TO RELATED APPLICATIONS

This application is a Continuation-In-Part of U.S. patent application Ser. No. 09/866,276, filed May 25, 2001, which is a Continuation-In-Part of U.S. patent application Ser. No. 09/851,354, filed on May 8, 2001, which claims the benefit of U.S. Provisional Application Serial No. 60/235,131, filed on Sep. 25, 2000.

### TECHNICAL FIELD

### BACKGROUND OF THE INVENTION

The present invention relates to a lifting and moving device. More particularly, the present invention relates to an improved apparatus and a method for removing and installing horizontally disposed heat exchanger bundles.

Heat exchangers are used in chemical processing plants, such as petroleum refineries and distilling facilities for absorbing heat created by high temperature reactions. These heat exchangers utilize long metal tubes arranged in a cylindrical bundle. The bundle is generally heavy and may vary in diameter and length. For example, often these bundles may average one to six feet in diameter, twelve to twenty-four feet long and may have a weight of two to forty tons. Further, the preceding diameter, length, and weight may be exceeded.

An individual bundle is typically inserted into a horizontally disposed shell and coupled to an inlet and an outlet in the heat exchanger system which typically has multiple bundles. To facilitate heat exchange, fluid enters into a bundle from its inlet in the heat exchanger thereby flowing through the individual tubes of the bundle and exits via the outlet. Heat exchanger fluid flows through the shell, past the outside of the tubes and the tube and shell fluids may travel through a series of horizontally stacked bundles before being collected for reuse or recycling. During use, the individual tubes of the bundle are subject to fouling and corrosion and also have a limited life. Thus, each bundle in the heat exchanger requires regular maintenance of the individual tubes of the bundle and eventual replacement thereof.

The physical size and weight of the bundles create significant obstacles for maintenance and replacement. For maintenance, the bundle must be removed from its shell by a bundle extractor and often transported to another on-site location or an off-site facility more suited to the work required. A large heat exchanger may have multiple bundles arranged in stacks, one above the other. Thus, the lowest bundle may be contained in a shell a few feet off of the ground while the highest may be over thirty feet above the ground.

Another obstacle is the need to support and balance the bundle as the bundle is pulled from its shell. This problem is compounded by the fact that these bundles vary in length. Thus, a method and apparatus are needed for removing these heat exchanger bundles at a wide variety of heights from ground level while keeping the bundles securely supported as they are pulled from their shells.

A heat exchanger bundle is typically removed from its shell by a pulling car or sled of the extractor that exerts a pulling force on a tube sheet which is fixed to the ends of the tube bundle. Significant force is often required to break the bundle free from its shell due to normal product corrosion between the bundle and tube sheet and the shell. A pulling mechanism such as a winch, hydraulic jack, or screw drive and motors are typically used with the extractor pulling sled to break the bundle free. Once free, the bundle is positioned on a sliding carriage mounted on a frame of the extractor such that the bundle carriage is moved along the frame as the bundle is pulled from its shell. Due to the weight and length of the bundle, the carriage and frame may be tilted to balance the bundle as the bundle is removed.

Different types of equipment have been used to support the carriage and frame of the extractors in their operative position for pulling of heat exchanger tubes bundles. U.S. Pat. Nos. 3,836,015 and 4,053,062 to Travis and U.S. Pat. Nos. 4,869,638 and 5,032,054 to Krajicek et al. disclose an aerial supported carriage and frame for being lifted by a crane and which may be moved off site using the crane or a helicopter. Another approach is mounting the frame to a telescoping column on a truck bed as disclosed in U.S. Pat. No. 4,575,305 to Krajicek et al. and U.S. Pat. No. 5,403,145 to Cradeur et al. Another extractor disclosed in U.S. Pat. No. 5,373,271 to Amuny uses four telescoping cylinders to support and lift the frame. U.S. Pat. No. 5,562,400 to Travis and U.S. Pat. No. 5,564,179 to Amuny disclose extractors that utilize wheels and drive means to provide a self-propelled bundle extractor and have outrigger lifting columns which raise the frame to the height of the bundle shell.

Extractors which require the use of cranes to position the frame at the shell of the heat exchanger bundle are not practical for use in areas with limited clearance between the heat exchanger unit and other structures. Similarly, extractors mounted on truck beds present the same space concerns. In these limited clearance areas, there may not be adequate space to position a crane or truck between the structures. Thus, a mobile extractor that is self-propelled and has a self-contained mechanism for raising and lowering its extractor frame is usually preferred due to the limited clearances between structures.

U.S. Pat. Nos. 5,562,400 and 5,564,179 disclose self-propelled extractors a support frame and carriage that are mounted on wheels with hydraulic cylinders or telescoping lifting columns. The extractor of the latter patent utilizes the lifting columns to raise both the support frame and carriage to the vertical position of the heat exchanger shell; whereas, U.S. Pat. No. 5,562,400 uses the lifting columns to raise only a carriage frame having a pulling sled and skids. Due to the extreme weight of the heat exchanger bundle, which can exceed forty tons, the use of rubber wheels is not practical because they cannot support the weight. However, rubber wheels can accommodate lighter bundle loads of about twenty five tons or less, for example, Therefore, steel wheels with polyurethane shells can be used for the heavier bundle loads which may be too heavy for rubber wheels.

One problem with self-propelled extractors of this type is that the heat exchanger units are typically located outside on asphalt or gravel surfaces which may become soft due to rain or sun exposure such that the steel wheels often dig into the surface as the extractor is moved across the surface or when turning. After the bundle is pulled onto the extractor, the added weight often embeds the wheels into the surface making it impossible for the extractor to move under its own power. As an alternative, a self-propelled extractor may provide for lifting the extractor with a crane such as that disclosed in U.S. Pat. No. 5,564,179. Due to the weight of the extractor and bundle, which may be over sixty-five tons, a large crane is required. Under some union rules, the operation of a large crane requires two workers, an operator and an oiler. However, for the operation of smaller cranes, only one worker is required, the operator. To support two shifts of extractor operations, the added oiler increases the labor costs approximately $6,000 to $8,000 per shift per week.

Another problem with known extractors is that the telescoping columns which lift the support frame and carriage of the extractor to the height of the shell become very unstable when the support frame is near or at the top of its vertical travel due to the progressive upwardly shifting of the extractor's center of gravity. The four telescoping columns usually have to support the entire weight of the support frame carriage and eventually the bundle, e.g. see U.S. Pat. No. 5,564,179. Furthermore, as the bundle is being pulled onto the carriage, the added weight of the bundle to the front of the extractor adjacent the shell shifts the center of mass of the extractor, rendering it unstable. Likewise, as the bundle is being pulled from the shell and onto the carriage, the changing position of its center of mass may tilt the extractor frame such that one of the front or the rear columns may support more weight than the others, which may cause the extractor to tilt or rock. Thus, added precautions must be taken to prevent or compensate for the sudden shifts in weight to prevent the extractor from overturning.

Accordingly, a method and apparatus are needed that provide a heat exchanger bundle extractor apparatus that remains stable when removing or installing heat exchanger bundles at high levels above ground surface. Further, a method and apparatus which can fit into tight spaces for accessing bundles, while still having stability during a pulling operation with the ability to transport a pulled bundle to another location thereafter, is needed.

Furthermore, a method and apparatus are needed that provide an improved heat exchanger bundle extractor apparatus that can maneuver around the plant or facility at relatively higher speeds to accommodate time constraints, yet at the same time continue to provide the flexibility discussed above.

### SUMMARY OF THE INVENTION

In accordance with the present invention, at least four wheel assemblies and main frame having a carriage frame with four vertical hydraulic cylinders may be used and may achieve the stability necessary to support and level a heat exchanger bundle during removal from its shell at various vertical heights and to move the extractor, with or without a bundle, across gravel, asphalt and uneven surfaces. Preferably, at least two of the wheel assemblies are individually powered and all four are individually steerable. The wheel assemblies are at least attached to a main frame and may be used to support and provide movement to the extractor. An engine, preferably an air cooled diesel engine, may be used to drive individual hydraulic motors which power and steer the wheel assemblies and may allow the extractor to be driven to and from the in-use location of the heat exchanger bundles. Each tire of each wheel assembly provides a large enough surface area to spread the load of the extractor and the bundle on the ground. Accordingly, the large constant surface area will prevent the unit from becoming embedded into the ground The wheel assemblies also provide a design which can accommodate speeds of up to 10 to 12 mphs.

Preferably, a first set of four hydraulic cylinders may be vertically mounted at the corners of a rectangular main frame of the extractor. The base of each cylinder may have a pad for engaging the ground and may have a spherical joint. When the extractor is stationary for removing a bundle, each pad may be positioned to match the grade of the ground to balance and support the extractor which may increase stability in its stationary position.

A second set of the hydraulic cylinders may be attached to a carriage frame and to the main frame. Actuating the piston may raise and lower the carriage frame with respect to the main frame. Accordingly, each cylinder may be independently controlled to tilt and level the carriage frame to compensate for a grade in the surface and the changing center of gravity of the extractor during removal of the bundle from its shell and during the raising and lowering of the carriage frame.

Alternatively, the extractor may be raised or moved using a crane or helicopter by removing the carriage frame from the main frame at disconnects located at the hydraulic cylinders and the main frame. Cylindrical horizontal shafts may be provided at each corner of the carriage frame for attaching slings to lift the carriage frame and bundle. Disconnecting the carriage frame from the main frame provides a lightweight, aerial extractor by eliminating the main frame, track, drive motor, and/or hydraulic cylinders.

In the preferred configuration the main frame, including the wheel assemblies, are lifted off the ground during the extraction and re-insertion phases by the lower portions of the hydraulic cylinders. Thus, the main frame remains off but relatively near the ground for increase stability.

In an embodiment, lifting members are provided having feet wherein the plurality of lifting members raise the frame.

In an embodiment, power cylinders having feet are provided wherein the power cylinders raise the frame.

In an embodiment, a pulling member is associated with the frame wherein the pulling member attaches to the heat exchanger bundle.

In an embodiment, a base frame and an upper frame are provided wherein the base frame is larger than the upper frame and the base frame remains fixed as the upper frame vertically shifts.

In an embodiment, a base frame portion and a smaller frame portion of the frame is provided wherein the smaller frame portion is detachable from the frame such that the heat exchanger bundle and the smaller frame portion may be lifted from the base frame portion.

In an embodiment, a connection is provided between the base frame portion and the smaller frame portion.

In an embodiment, the frame has a length substantially aligned with that of the heat exchanger bundle.

In another embodiment of the present invention, a method is provided for supporting a load to be removed four an in-use location. The method comprises the steps of: providing an apparatus for removing the heavy load; providing a propelling mechanism on the apparatus; providing at least four wheel assemblies; aligning a vertically shiftable frame portion of the apparatus with the load; removing the load from the in-use location; shifting the load onto the frame portion; spreading the load over a predetermined area on a support surface adjacent to the in-use location; and stabilizing the apparatus as the load is shifted.

In an embodiment, integrating the propelling mechanism provided with the apparatus such that the apparatus is self-propelled.

In an embodiment, maneuvering the apparatus onto the support surface is provided.

In an embodiment, a first frame portion and a second frame portion of the apparatus is provided wherein the first frame portion is aligned with the load to be removed and wherein the first frame portion has connections associated with the second frame portion.

In an embodiment, connecting a lifting device to the connections on the first frame portion is provided.

In an embodiment, disconnecting the first frame portion from the second frame portion is provided.

In an embodiment, lifting the first frame portion and the load is provided.

In an embodiment, the load is one of a plurality of heat exchanger bundles that are at various levels of elevation relative to the support surface.

In an embodiment, pulling the load and progressively shifting the load onto the frame portion is provided.

In another embodiment of the present invention, a method is provided for supporting and moving a heat exchanger bundle over a transport surface. The method comprises the steps of: providing a mobile extractor apparatus having a carriage frame and a main frame; providing a propelling mechanism for moving the apparatus along the transport surface; raising the carriage frame relative to the main frame to the height of the heat exchanger bundle wherein the main frame is elevated above, but remains relatively near the transport surface; pulling the heat exchanger bundle onto the carriage frame; lowering the carriage frame and the heat exchanger bundle toward the transport surface; powering and steering the main frame using the propelling mechanism; transporting the heat exchanger bundle; and supporting the heat exchanger bundle with the apparatus, the carriage frame, and the main frame while maintaining a surface area of engagement between the engaging surface and the transport surface.

In another embodiment of the present invention, the method actuates hydraulic cylinders of the mobile extractor apparatus to raise the carriage frame.

In another embodiment of the present invention, a method is provided for supporting and moving a heat exchanger bundle. The method comprises the steps of: providing a mobile extractor apparatus having a carriage frame, a main frame, and a propelling mechanism; moving the mobile extractor apparatus along the surface with the propelling mechanism; raising the main frame, raising the carriage frame relative to the main frame; lifting the carriage frame from the main frame to the height of the heat exchanger bundle while the main frame remains relatively near the surface; pulling the heat exchanger bundle onto the carriage frame; lowering the carriage frame and the heat exchanger bundle toward the transport surface; connecting a lifting device to the carriage frame; disconnecting the carriage frame from the main frame; and lifting the carriage frame and the heavy heat exchanger bundle supported by the carriage frame while the main frame and propelling mechanism remain in contact with the engaging surface.

In an embodiment, the method actuates hydraulic cylinders of the mobile extractor apparatus to lift the carriage frame.

Additional features and advantages of the present invention are described in, and will be apparent from, the detailed description of the presently preferred embodiments and from the figures.

### BRIEF DESCRIPTION OF THE FIGURES

FIG. 1 illustrates a perspective view of an embodiment of the apparatus for extracting and installing heat exchanger bundles.

FIG. 2 illustrates a perspective view of another embodiment of the apparatus for extracting and installing heat exchanger bundles.

FIG. 3 illustrates an elevation view of yet another embodiment of the apparatus for extracting and installing heat exchanger bundles.

FIG. 4 illustrates a plan view looking up of the embodiment of the apparatus as shown in FIG. 3.

FIG. 5 illustrates an elevation view of the ultimate embodiment of the apparatus shown in FIG. 3 in an operating mode with the wheel assemblies lifted off the ground and beginning the extraction of a heat exchanger.

FIG. 6 is a perspective view of the sled assembly of the ultimate embodiment shown in FIG. 3.

FIG. 7 is a detail view of the sled shown in FIG. 6.

FIG. 8 is a partial elevation view of the embodiment of the invention shown in FIG. 3 in operational mode.

FIG. 9 is also a partial elevation view of the invention shown in FIG. 3 in operational mode.

### DETAILED DESCRIPTION OF THE PREFERRED EMBODIMENTS

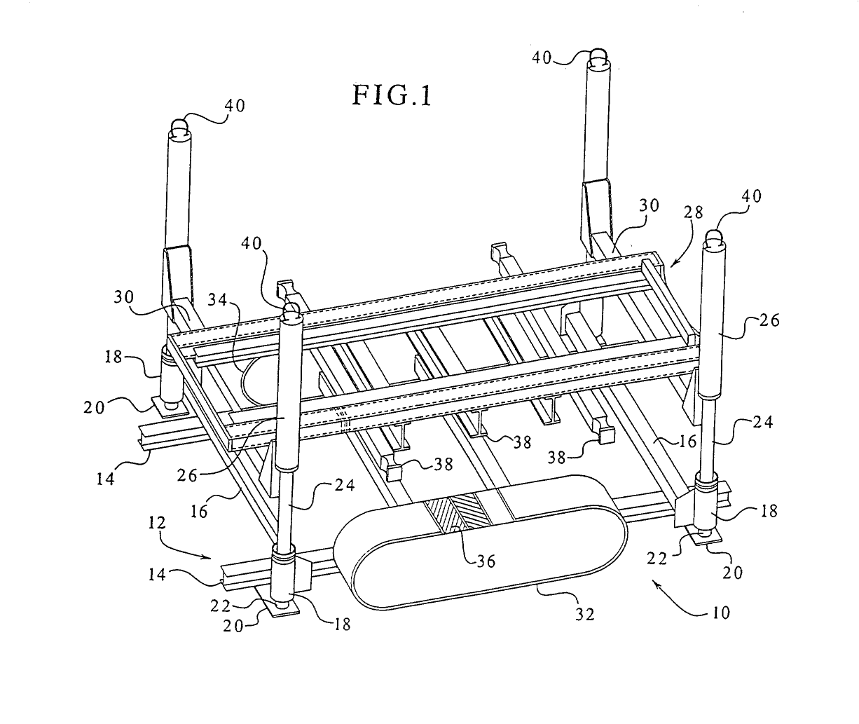

As shown in drawings for purposes of illustration, the invention is embodied in a heat exchanger tube bundle extractor apparatus 10. As shown in FIG. 1, the extractor apparatus 10 is embodied in a rectangular main frame 12 having a long pair of parallel members 14 and shorter parallel cross members 16. At each intersection of the long member 14 and the cross members 16 is a base cylinder 18 which may be attached thereto. Each base cylinder 18 may have a support pad 20 having approximately seventy-five square inches of surface area for engaging the ground. The support pad 20 may be attached to eight inner cylinders 22 which may be received by the base cylinder 18 such that the support pad may be lowered to the ground.

One form of the extractor apparatus 10 may utilize a spherical joint (not shown) so that the angle in which support pad 20 may engage the ground may be adjusted to accommodate the grade of the ground at a location of each of the support pads 20. Thus, each of the support pads 20 and the inner cylinder 22 may have a spherical joint so that each of the support pads 20 may be independently adjusted to increase stability of the extractor apparatus 10 when in a stationary position.

The base cylinder 18 may also receive a piston 24 from a hydraulic cylinder 26. The upper portion of the hydraulic cylinder 26 may be attached to a carriage frame 28. The carriage frame 28 may also be rectangular; however, it is smaller than the main frame 12. The carriage frame 28 may have two shorter cross members 30 at each end which may be detachably mounted to the hydraulic cylinders 26 by disconnects (not shown). When the piston 24 of the hydraulic cylinder 26 is actuated, the carriage frame 28 may be raised above main frame 12. Each of the hydraulic cylinders 26 may be independently actuated to raise and tilt the carriage frame 28 to compensate for any grade in the support surface and the changing center of gravity due to the weight of the heat exchanger bundle (not shown) as the heat exchanger bundle is pulled onto the carriage frame 28 as described herein. Independent actuation of the hydraulic cylinders 26 may eliminate the need for leveling devices on the carriage frame 28, thereby reducing weight and minimizing the number of moving parts requiring maintenance.

When the hydraulic cylinders 26 are actuated, the pistons 24 may be driven downward which in turn may raise the carriage frame 28 above main frame 12 which may remain stationary. With the main frame 12 position close to the ground, the extractor apparatus 10 may maintain stable as the carriage frame 28 rises. In its lowest position above the main frame 12, the carriage frame 28 may be used to remove heat exchanger bundles as low as forty-three inches off of the ground if a track assembly is used. When the hydraulic cylinders 26 are actuated to the their full length of the pistons 24, the carriage frame 28 may be approximately fifteen feet above the ground.

Mounted to each parallel long member 14 of the main frame 12 may be tracks 32 and 34. The tracks 32 and 34 have plates 36 which may be made from polystyrene and may have a large smooth surface for engaging the ground. The smooth surface of the plates 36 as compared to those having ridges or tread, may maximize the surface area of the plate for supporting the weight of the extractor apparatus 10 and heat exchanger bundle (not shown).

Alternatively, the smooth surface of the plates 36 may be replaced with a surface having tread for use on slippery terrain such as mud or loose gravel. The plates 36 may be approximately fourteen inches in width and may be positioned one after the other with a space between each of the plates 36. The plates 36 may be joined by fastening devices to compose the continuous eight foot tracks 32 and 34.

The tracks 32 and 34 may be supported by a frame (not shown) with a drive member (not shown) to rotate the tracks 32 and 34 about the frame which, in turn, provides translation of the extractor apparatus 10. The tracks 32 and 34 and frame configuration may provide a predetermined, large area of approximately sixteen square feet in contact with the ground at all times. An engine (not shown) may provide the power to rotate the tracks 32 and 34 about the frame. As known in the art of track driven equipment, the tracks 32 and 34 are independently driven such that the extractor apparatus 10 may be turned by holding one track stationary while rotating the opposite track, which causes the extractor apparatus 10 to rotate in the direction of the track being held.

On the carriage frame 28 may be a series of sliding cross members 38 which may allow for adjusting the width of carriage frame 28 to accommodate the heat extractor bundles of varying width. The width of the carriage frame 28 may be adjusted for a particular diameter of the heat extractor bundle before or after transporting the heat exchanger bundle and the extractor apparatus 10 to the shell.

The extractor apparatus 10 may be transported to the work location by an engine that may provide power to the tracks 32 and 34. The support pads 20 may be lowered to the ground by extending the inner cylinder 22 downwards from the base cylinder 18 such that the support pad 20 is firmly planted on the ground. The support pads 20 may have a diameter of approximately seventy-five square inches and may be twice as great as that of the inner cylinder 22.

Each of the base cylinders 18 may have independent movement to accommodate uneven surfaces. After the support pads 20 are firmly planted, the hydraulic cylinders 26 may be used to raise the carriage frame 28 to the height of the shell where the heat exchanger bundle is located. The carriage frame 28 may rise as the piston 24 of each of the hydraulic cylinders 26 is actuated. The system of the hydraulic cylinders 26 and the pistons 24 may allow the main frame 12 to remain low to the ground to provide stability and a low center of gravity. Furthermore, each of the hydraulic cylinders 26 may be independently actuated, to compensate for uneven surfaces by leveling the carriage frame 28.

After the carriage frame 28 is at the proper height location at the shell, the width of the carriage frame 28 may be adjusted using the sliding cross members 38 to accommodate the diameter of the heat exchanger bundle. A sled (not shown) that is mounted to carriage frame 28 may be used to attach the heat exchanger bundle to the extractor apparatus 10. A chain or wire cable may be used to secure the heat exchanger to the sled (not shown). The sled may also utilize a small motor (not shown) on the main frame 12 to move the sled that in turn may pull the attached heat exchanger bundle on to the carriage frame 28. As the weight of the heat exchanger bundle shifts on the carriage frame 28, the hydraulic cylinders 26 may be adjusted to keep the heat exchanger bundle level or parallel with the ground and to keep the apparatus stable and prevent tipping of the apparatus.

When the heat exchanger bundle is completely removed from the shell, the extractor apparatus 10 may be used to transport the heat exchanger bundle to a remote location for further inspection and maintenance work. The tracks 32 and 34 may be used to move the extractor apparatus 10 with the heat exchanger tube bundle carried on the carriage frame 28. This method of movement may be used to transport the heat exchanger tube bundle to the remote location, or in the alternative, the carriage frame 28 may be removed from the main frame 12 at the base cylinders 18 or alternatively at the hydraulic cylinders 26. Cables or chains (not shown) may be attached to hooks 40 to provide a means for lifting the carriage frame 28 and the heat exchanger bundle from the main frame 12 and thereby leaving the tracks 32 and 34 on the ground along with the engine. This provides a lighter weight system that may be aerially removed using a crane or helicopter. Furthermore, the carriage frame 28 and heat exchanger bundle may be aerially removed and loaded on a flatbed truck or railcar for transportation offsite.

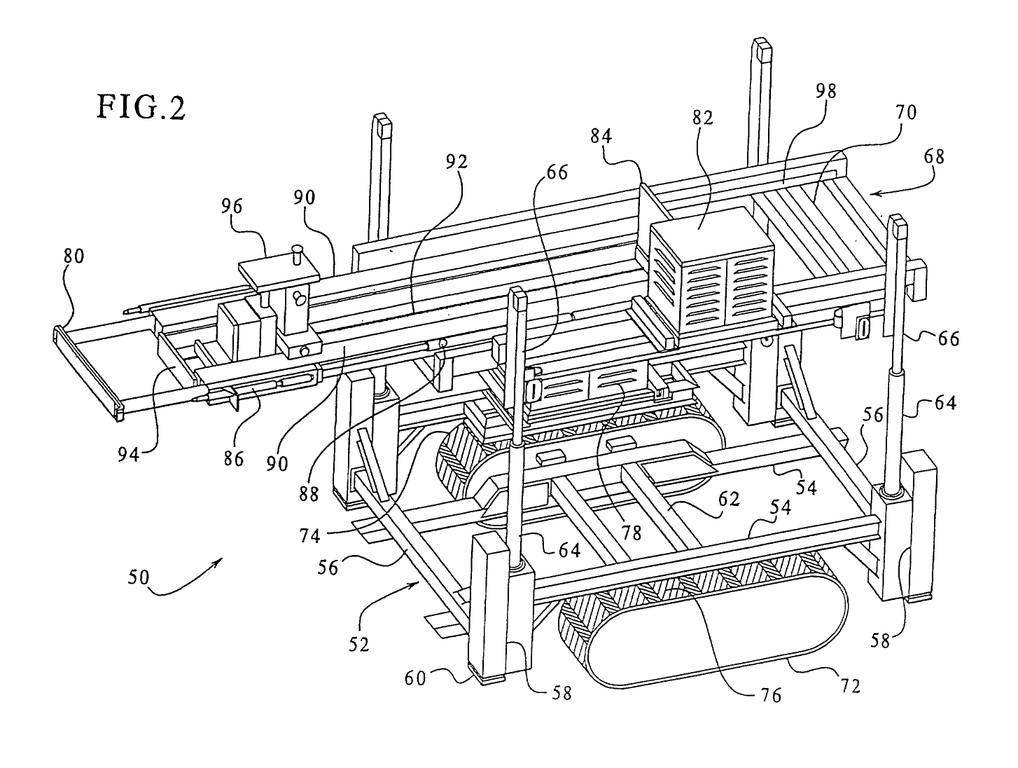

Referring now to FIG. 2, in another embodiment of the present invention, another extractor apparatus 50 is illustrated. As shown in FIG. 2, the extractor apparatus 50 is embodied in a rectangular main frame 52 having a long pair of parallel members 54 and shorter parallel cross members 56. At each intersection of the long member 54 and the cross members 56 is a siamese cylinder 58 which may be attached thereto. Each siamese cylinder 58 may have a support pad 60 having approximately seventy-five square inches of surface area for engaging the ground. The support pad 60 may be attached to eight inner cylinders (not shown) which may be received by the siamese cylinder 58 such that the support pad 60 may be lowered to the ground.

One form of the extractor apparatus 50 may utilize a spherical joint (not shown) so that the angle in which the support pad 60 may engage the ground may be adjusted to accommodate the grade of the ground at a location of each of the support pads 60. Thus, each of the support pads 60 and the inner cylinders (not shown) may have a spherical joint so that each of the support pads 60 may be independently adjusted to increase stability of the extractor apparatus 50 when in a stationary position.

The siamese cylinder 58 may also receive a piston 64 from a hydraulic cylinder 66. The upper portion of the hydraulic cylinder 66 may be attached to a carriage frame 68. The carriage frame 68 may also be rectangular. The carriage frame 68 may have two shorter cross members 70 at each end which may be detachably mounted to the hydraulic cylinders 66 by disconnects (not shown). When the piston 64 of the hydraulic cylinder 66 is actuated, the carriage frame 68 may be raised above main frame 52. Each of the hydraulic cylinders 66 may be independently actuated to raise and/or tilt the carriage frame 68 to compensate for any grade in the support surface and the changing center of gravity. The center of gravity may change due to the weight of the heat exchanger bundle (not shown) as the heat exchanger bundle is pulled onto the carriage frame 68 as described herein. Independent actuation of the hydraulic cylinders 66 may eliminate the need for leveling devices on the carriage frame 68, thereby reducing weight and/or minimizing the number of moving parts requiring maintenance.

When the hydraulic cylinders 66 are actuated, the pistons 64 may be driven downward which in turn may raise the carriage frame 68 above the main frame 52 which may remain stationary. With the position of the main frame 52 close to the ground, the extractor apparatus 50 may maintain stable as the carriage frame 68 rises. In the range from the lowest position and the highest position of the carriage frame 68 above the main frame 52, the carriage frame 68 may be used to remove heat exchanger bundles. The carriage frame 68 may be positioned as low as forty-three inches off of the ground when using a track assembly. When the hydraulic cylinders 66 are actuated to the their full length of the pistons 64, the carriage frame 68 may be positioned approximately fifteen feet above the ground.

Mounted to each parallel long member 54 of the main frame 52 may be tracks 72 and 74. The tracks 72 and 74 have plates 76 which may be made from polystyrene and may have a large smooth surface for engaging the ground. The smooth surface of the plates 76 as compared to those having ridges or tread, may maximize the surface area of the plate for supporting the weight of the extractor apparatus 50 and heat exchanger bundle (not shown).

Alternatively, the smooth surface of the plates 76 may be replaced with a surface having tread for use on slippery terrain, such as mud or loose gravel. The plates 76 may be any length, however, preferably, the plates are approximately fourteen inches in width and may be positioned one after the other with a space between each of the plates 76. The plates 76 may be joined by fastening devices (not shown) to compose the continuous eight foot tracks 72 and 74.

The tracks 72 and 74 may be supported by a frame 62 with a drive member (not shown) to rotate the tracks 72 and 74 about the frame which, in turn, provides translation of the extractor apparatus 50. The tracks 72 and 74 and the configuration of the frame 62 may provide a predetermined, large area in contact with the ground at all times. Preferably, predetermined large area of the track may be approximately sixteen square feet. An engine 78 may provide the power to rotate the tracks 72 and 74 about the frame 62. As known in the art of track driven equipment, the tracks 72 and 74 may be independently driven such that the extractor apparatus 50 may be turned by holding one track stationary while rotating the opposite track, which causes the extractor apparatus 50 to rotate in the direction of the track being held.

On the carriage frame 68 may be a series of sliding cross members (not shown) which may allow for adjusting the width of carriage frame 68 to accommodate the heat extractor bundles of varying width. The width of the carriage frame 68 may be adjusted for a particular diameter of the heat extractor bundle before or after transporting the heat exchanger bundle and the extractor apparatus 50 to the shell.

The extractor apparatus 50 is transported to the work location by the engine 78 that may provide power to the tracks 72 and 74. After the extractor apparatus 50 is at the proper location, the support pads 60 may be lowered to the ground by extending the inner cylinders downwards from the siamese cylinder 58 such that the support pads 60 may be firmly planted on the ground. The support pads 60 may have a diameter of approximately seventy-five square inches and may be twice as great as that of the inner cylinders.

Each siamese cylinder 58 may have independent movement to accommodate uneven surfaces. After the support pads 60 are firmly planted, the hydraulic cylinders 66 may be used to raise the carriage frame 68 to the height of the shell where the heat exchanger bundle is located. The carriage frame 68 may rise as the piston 64 of each of the hydraulic cylinders 66 is actuated. The system of the hydraulic cylinders 66 and the pistons 64 may allow the main frame 52 to remain low to the ground to provide stability and a low center of gravity. Furthermore, each of the hydraulic cylinders 66 may be independently actuated to compensate for uneven surfaces by leveling the carriage frame 68.

After the carriage frame 68 is at the proper height location at the shell, the width of the carriage frame 68 may be adjusted, and a grabber 80 that may be mounted to carriage frame 68 may be used to attach the heat exchanger bundle (not shown) to the extractor apparatus 50. A chain or wire cable (not shown) may be used to secure the heat exchanger to the grabber 80 and to cylinders 86. A grabber cylinder 88 on each of beams 90 of the carriage frame 68 may move the grabber 80 a distance out relative to the carriage frame 68.

The carriage frame 68 may have a plate 84. A motor 82 on the carriage frame 68 may rotate a pump (not shown) that may power a hydraulic motor (not shown) which may power a hydraulic brake (not shown) that may power an actuator (not shown) that, in turn, may rotate a screw 92. The screw 92 may be attached at to the plate 84 at one end and to a trough 94 at another end. The trough 94 holds a sled 96. The sled 96 may be moved forward or back by the screw 92. The sled 96 moves within the trough 94. The trough 94 may be housed within the beams 90. Beam cylinders 98 may move the beams 90 forward and back relative to the carriage frame 68. Thus, the carriage frame 68 preferably has three sections that may move relative to the carriage frame: the grabber 80, the beams 90 and the sled 96. The grabber 80 and the beams 90 may extend the length of the carriage frame 68.

After the carriage frame 68 is in place, the chain or wire cable may be used to secure the heat exchanger to the grabber 80 and to cylinders 86. The grabber 80 may then be pulled back by the grabber cylinder 88 on each of the beams 90. The grabber 80 and the cylinders 86 may break the heat exchanger bundles out of their shell and pull the heat exchanger bundles onto the sled 96 of the carriage frame 68. The sled 96 and the beams 90 may retract to pull the heat exchanger bundle fully onto the carriage frame 68.

As the weight of the heat exchanger bundle shifts on the carriage frame 68, the hydraulic cylinders 66 may be adjusted to keep the heat exchanger bundle level or parallel with the ground and to keep the extractor apparatus 50 stable and prevent tipping of the extractor apparatus 50.

When the heat exchanger bundle is completely removed from the shell, the extractor apparatus 50 may be used to transport the heat exchanger bundle to a remote location for further inspection and maintenance work. The tracks 72 and 74 may be used to move the extractor apparatus 50 with the heat exchanger tube bundle carried on the carriage frame 68. This method of movement may be used to transport the heat exchanger bundle to the remote location, or in the alternative, the carriage frame 68 may be removed from the main frame 52 at the siamese cylinders 58 or alternatively at the hydraulic cylinders 66.

Cables or chains (not shown) may be attached to the carriage frame 68 to provide a means for lifting the carriage frame 68 and the heat exchanger bundle from the main frame 52 and thereby leaving the tracks 72 and 74 on the ground along with the engine 78. Removing the carriage frame 68 from the main frame 52 provides a lighter weight system that may be aerially removed using a crane or helicopter. Furthermore, the carriage frame 68 and the heat exchanger bundle may be aerially removed and loaded on a flatbed truck or railcar for transportation offsite.

Alternatively, the carriage frame 68 may be removed from the main frame 52 and aerially transported without the main frame 52 and engine 78 to the work location before extracting the heat exchanger bundles. After the carriage frame 68 is transported to the work location and is at the proper height location at the shell, the sled 80 that is mounted to the carriage frame 68 may be used to attach the heat exchanger bundle to the carriage frame 68. The small motor 82 may move the sled 80 that, in turn, may pull the attached heat exchanger bundle onto the carriage frame 68.

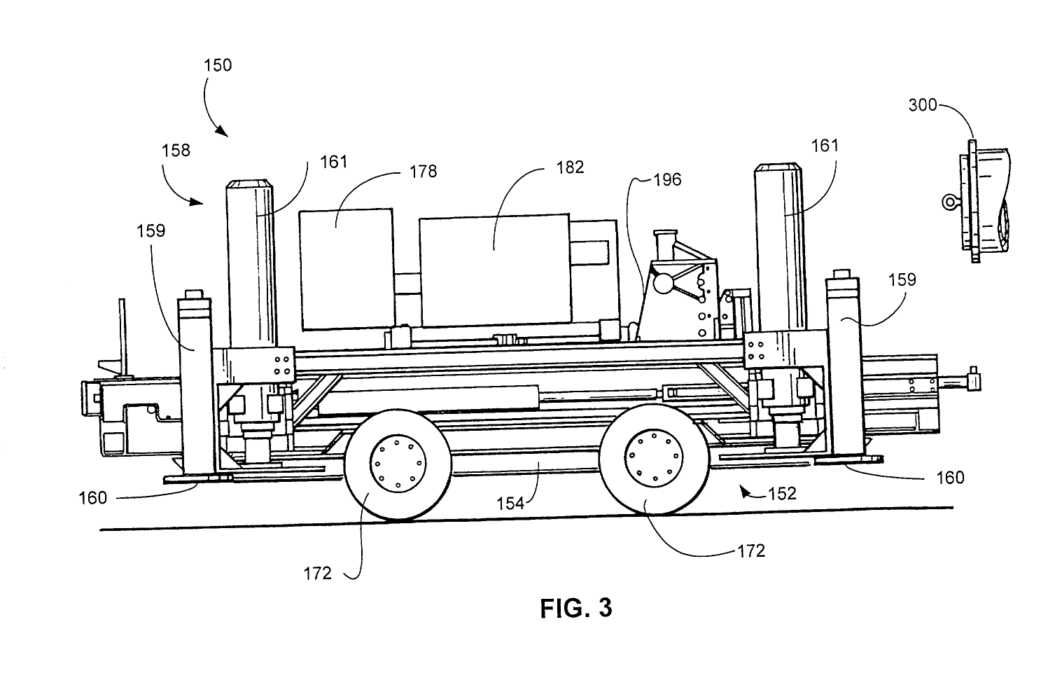

Referring now to FIGS. 3-7, an alternate embodiment of the present invention is shown. The reference numerals in these figures are in the 100 series and generally the last two digits of these numbers correspond with the similar element of the embodiment shown in FIG. 2 and discussed in association with FIG. 2.

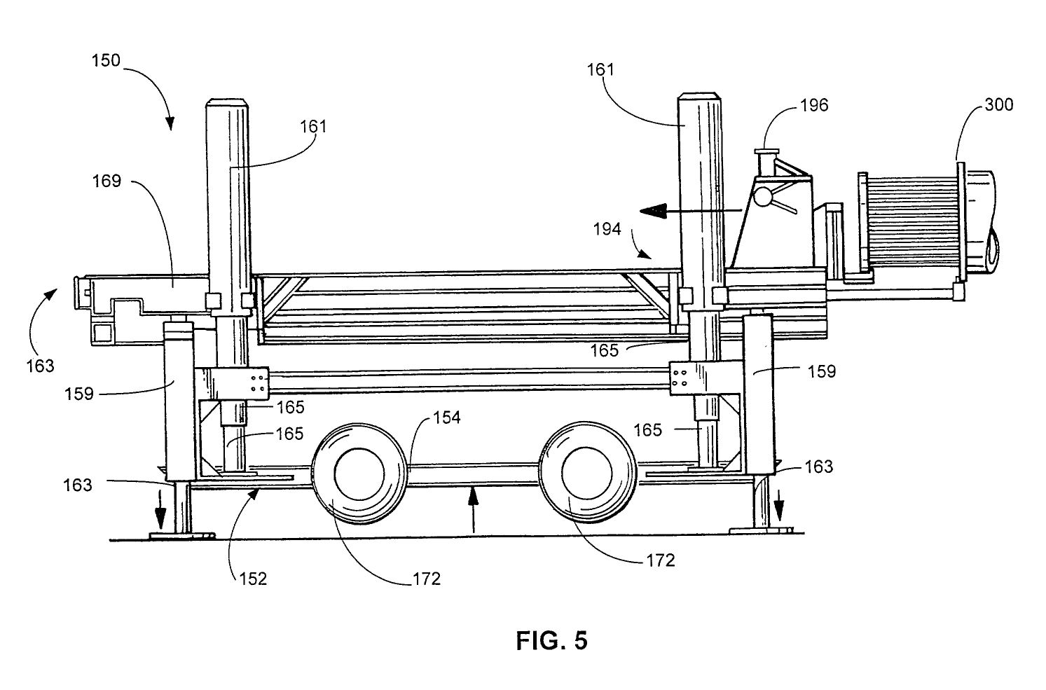

Referring to FIGS. 3-5, extractor apparatus 150 is illustrated which includes a rectangular main frame 152 comprised generally of longitudinal parallel members 154 and shorter transverse members 156. At the corner intersections of members 154 and cross-members 156 are located four siamese cylinder assemblies 158. Each siamese cylinder assembly 158 includes a first cylinder assembly 159 and a second cylinder assembly 161. Cylinder assembly 159 is preferably a hydraulic cylinder having an internal piston 163 attached to a support pad 160. Referring to FIG. 5, second assembly 161 includes telescoping pistons 165.

Extractor apparatus 150 also includes a carriage frame 168 which is composed of longitudinal numbers 169 and transverse cross-members such as members 70 in FIG. 2.

As shown in FIG. 5, the outer housing portion of cylinder assembly 161 is mounted to longitudinal members 169 of carriage frame 168 while the end of telescoping member 165 is mounted to main frame 154. In this manner, hydraulic activation of first cylinder assembly 159 will extend piston rods 163 until support pads 160 contact the ground surface, thereby elevating both main frame 152 and everything associated with main frame 152, such as carriage frame 168.

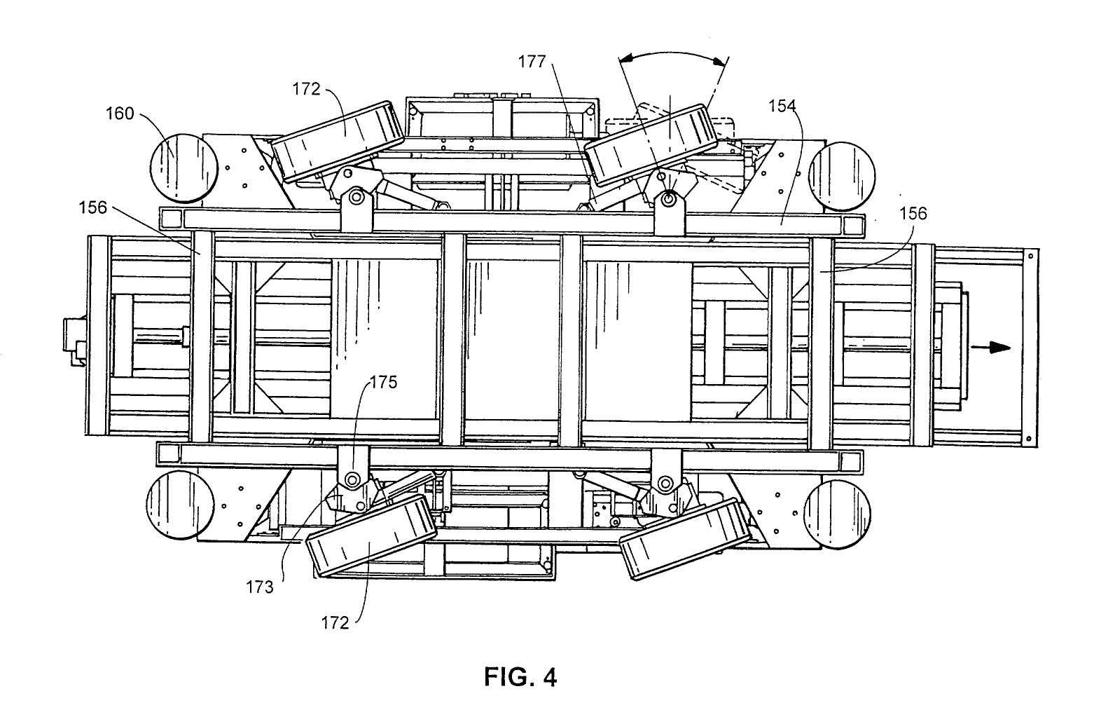

Referring to FIG. 3 the extractor apparatus 150 also includes four wheel assemblies 172. One of the principal differences in this embodiment from the embodiment shown in FIGS. 1 and 2 is the substitution of four wheel assemblies 172 for the tracks 32 and 34 of FIG. 1 and 72 and 74 of FIG. 2. Referring to FIG. 4, each wheel assembly 172 is pivotally attached to a longitudinal frame 154 by a pivot plate 173 attached to member 154 at pivot point 175. Each wheel assembly 172 is therefor pivotable relative to member 154 by extending or contracting hydraulic cylinder 177. In this manner, steering motion is provided to each wheel assembly. Also, each wheel is individually steerable which permits the operator to locate the extractor apparatus 150 proximate the shell assembly 300.

Additionally, at least two of the four wheel assemblies are powered by a hydraulic direct drive wheel motor mounted within the wheel. Such hydraulic motors are commonly known to those skilled in the art. See, for example, Model MS-18 which may be purchased from the French company Poclain Hydraulics. These hydraulic motors provide the power necessary to advance the extractor apparatus 150 in a forward or reverse mode. The hydraulic motors may be driven, for example, by engine 178, which is a diesel engine used to generate hydraulic pressure necessary to drive the motors. Similarly, extractor apparatus 150 would include a control system commonly known to those skilled in the art to control the operation of each hydraulic drive motor to advance it forward and rearward and to control the steering of each wheel assembly.

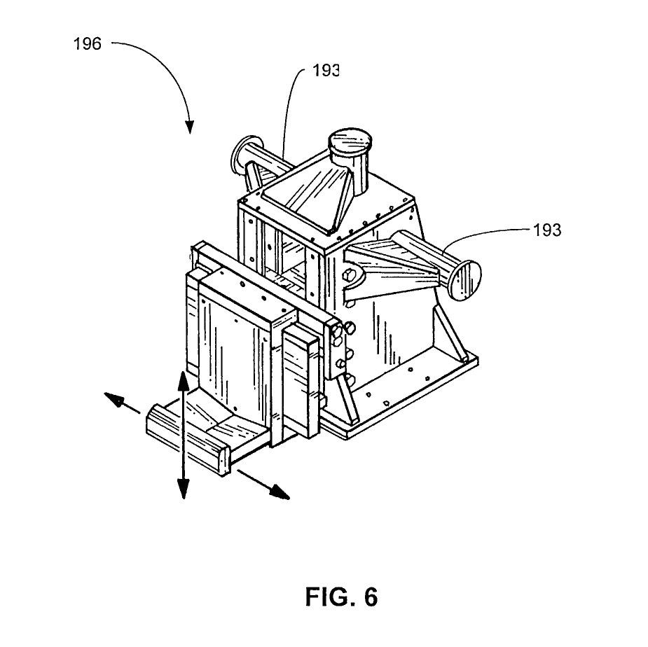

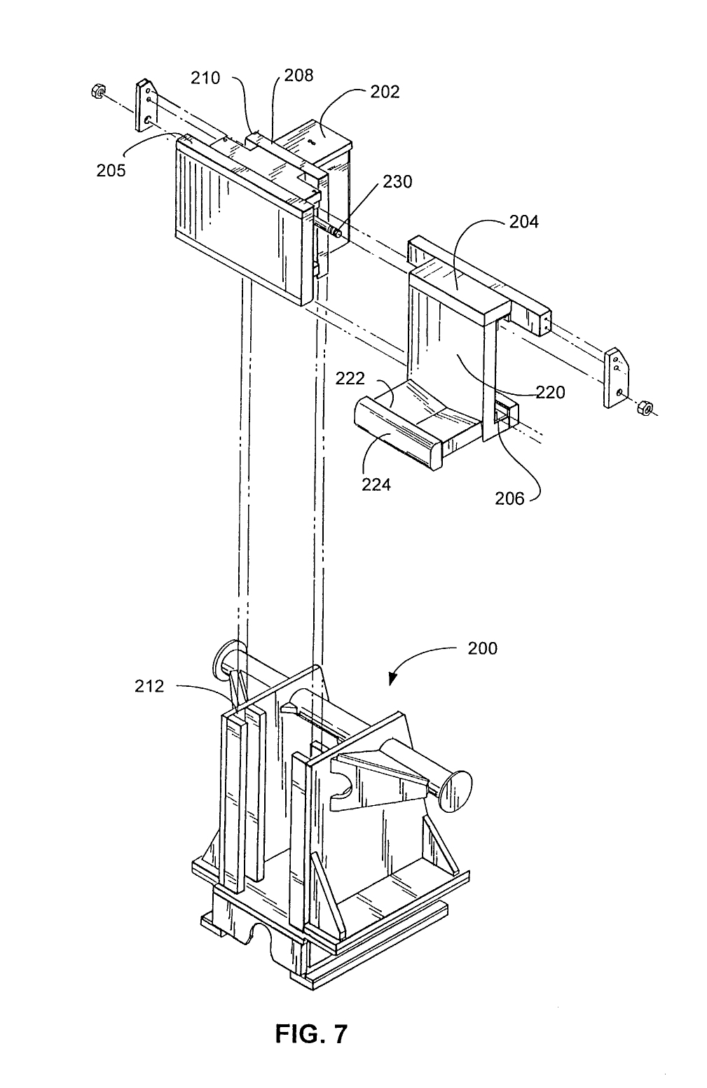

Other than the substitution of wheel assemblies 172 for tracks 32/36 and 72/74 of the earlier embodiments, the operation of the extractor assembly 150 is identical to that illustrated in FIGS. 1 and 2 and discussed earlier. For example, extractor apparatus 150 includes not only a main frame 152 and a carriage frame 156 with corresponding parts as discussed above, but it would also include a motor 182 which is mounted on the carriage frame to rotate a pump that in turn would rotate a screw such as screw 92 as shown in FIG. 2. As before, screw 92 which may be located in the extractor apparatus 150 would be housed within a trough 94 as shown in FIG. 2 and discussed above. A sled 96 may be moved forward and backward by the screw 92 as discussed above. However, in the extractor apparatus 150, the sled 196 would preferably be used as described and shown more fully in FIGS. 6 and 7.

Referring now to FIGS. 6 and 7, sled 196 is composed of a base portion 200, which slides within a trough 194 which is similar in structure to that shown and described as trough 94 in FIG. 2. Base portion 200 supports two moving sections: vertical transfer section 202 and horizontal transfer section 204. As shown in FIG. 7, section 204 is supported on section 202 and is capable of moving transversely with respect to sections 202 along lip portion 205 which slides within grooves 206 of portion 204. Preferably, Teflon pads would be located on these contact surfaces to facilitate a smooth movement of portion 204 relative to 202. Similarly, vertical portion 202 is supported within base portion 200. Again, plate 208 of portion 202 includes end surfaces 210 which slide within channel 212 of base portion 200. In this manner, vertical movement of portion 202 will also result in vertical movement of portion 204. Portion 204 also includes a vertical member 220 and horizontal members 222. A lip 224 is attached at the end of members 222. In this manner, vertical and horizontal movement of portions 202 and 204 will permit the operator to move plates 222 and 224 relative to the precise end position of the heat exchanger within the shell assembly thereby enabling the operator to grab the end of the heat exchanger and remove it from the shell assembly as discussed in more detail below.

Horizontal movement of portion 204 relative to vertical portion 202 is achieved by double actuating hydraulic cylinder 230. As a double acting cylinder, single movement of this cylinder will enable easy relative movement of portion 204 relative to portion 202. Similarly, vertical movement of piece 202 is provided through the use of a hydraulic cylinder (not shown) which moves piece 202 (and therefore piece 204) relative to base portion 200.

As noted above with respect to the embodiment shown in FIG. 2, the embodiment shown in FIGS. 3-5 would also include beam cylinders 98 which move beam 90 forward and back relative to the carriage frame 168. Thus, the carriage frame 168 preferably has three sections that may move relative to the carriage frame: gripper bars 180, beams 90 and sled 196. The gripper bars 180 and the beams 90 (shown as FIG. 2) may extend the length of the carriage frame 168.

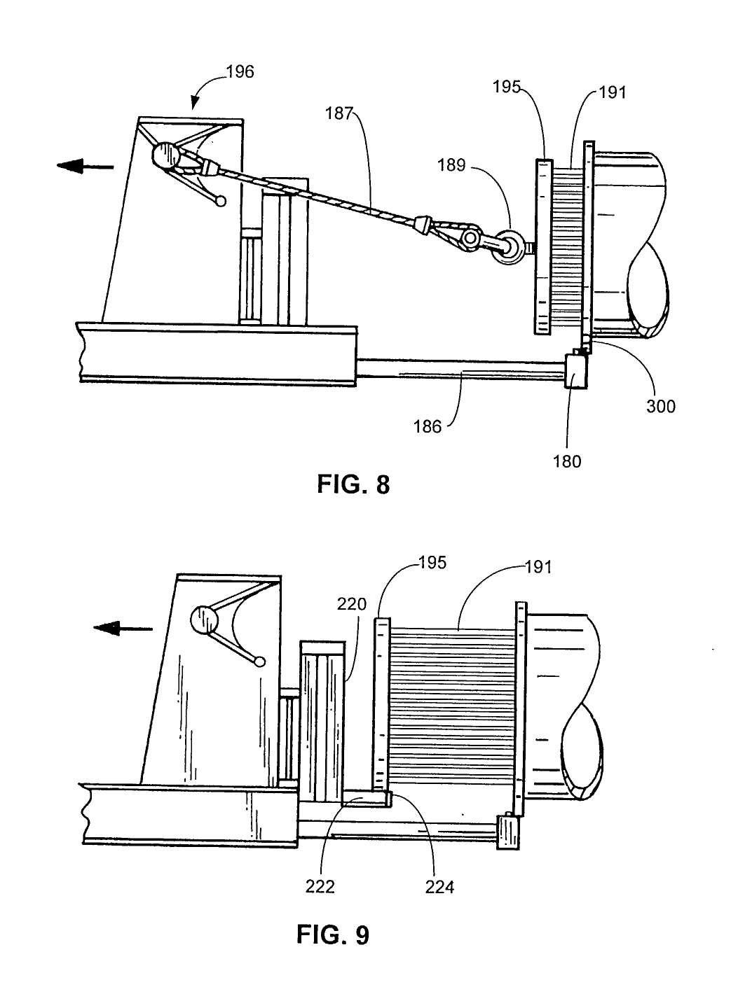

Referring now to FIGS. 8 and 9, and in particular first FIG. 8, the grabber 180 is extended to buttress against shell assembly 300. This is accomplished by cylinders 186 (see also FIG. 2). At that point, a sling 187 as shown in FIG. 8 may be attached through a threaded eyebolt 189 to the heat exchanger 191 and looped over one of the pins 193 of sled 196. In this manner, the slack in sling 187 can be taken up by activation of cylinder 88 (see FIG. 2) which pushes grabber 180 against shell 300. The heat exchanger 191 is thus broken out of the shell. The sled 196 may then be retracted by rotation of the screw 92 (see FIG. 2) a sufficient distant to enable the sled 196 to advance forward under the lip 195 of heat exchanger 191 as shown in FIG. 9.

As noted above, it may not be possible to precisely position the plates 222 and lip 224 of sled 196 immediately below flange 195 of exchanger 191. If the alignment is not correct, the operator may activate the vertical cylinders of sled 196 thereby moving pieces 202 and 204 relative to base portion 200 as well as the double acting cylinder 230 which moves portion 204 horizontally relative to portion 202. In this manner, the operator may precisely position the plates 222 and the lip 224 of sled 196 immediately below the flange 195 as shown in FIG. 9. At that point, the sling 187 can be removed and the rotating screw 92 (see FIG. 2) can then be activated to advance sled 196 to the left as shown in FIG. 9 extracting the heat exchanger 191 from shell 300.

As noted above with respect to FIG. 2, this extraction will continue until the heat exchanger bundle is fully supported by the carriage frame 168. As the weight of the heat exchange bundle shifts onto the carriage frame 68, the hydraulic cylinder 66 (see FIG. 2) can be adjusted to keep the heat exchanger bundle level and parallel with the ground and to keep the extractor apparatus 150 stable and prevent tipping or excessive movement.

When the heat exchanger bundle is completely removed from the shell 300, the extractor apparatus 150 may be used to transport the heat exchanger bundle to a remote location for further inspection and maintenance. That is, cylinder assemblies 161 are activated lowering the carriage frame 168 onto main frame 152. At that point, cylinder assemblies 159 are activated lowering wheel assemblies 172 to the ground. In this embodiment, it is anticipated that the wheels would be lifted a maximum of approximately 2 to 3 feet off the ground and that the unit itself is capable of lifting extractors up to about 25 to 30 tons at a height of approximately 20-25 feet.

As noted above with respect to the embodiments shown in FIGS. 1 and 2, the carriage frame 168 may be removed from the main frame 152 and aerially transported without the main frame 152 and wheel assemblies 172. In this manner, the carriage frame 168 may be transported to a work location that is at a location higher than would otherwise be accommodated by extractor apparatus 150.

Unless otherwise indicated herein with respect to extractor apparatus 150, the operation of extractor 150 is identical to that of the extractor apparatus 10 and 50 as shown and discussed with respect to FIGS. 1 and 2, respectfully.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

What is claimed is:

1. An apparatus for removing a heat exchanger bundle and transporting the bundle along a surface, the apparatus comprising:
a first frame;
a first propelling mechanism supported on the first frame;
at least four wheel assemblies coupled to said first frame and being powered by said first propelling mechanism;
a second frame above the first frame;
a second propelling mechanism on the second frame;
a vertically shiftable portion associated with the first frame for vertically elevating the first and second frame relative to the surface thereby lifting the wheel assemblies off the surface, and for elevating the second frame relative to the first frame;
a horizontally shiftable portion associated with the second frame for horizontally shifting a portion of the second frame; and
a sled associated with the second propelling mechanism wherein the sled is attached to the second frame.

2. The apparatus of claim 1 further comprising:
a pulling member associated with the second frame wherein the pulling member attaches to the heat exchanger bundle.

3. The apparatus of claim 1 further comprising:
a connection between the second frame and the vertically shiftable portion such that the second frame is detachable from the vertically shiftable portion such that the heat exchanger bundle and the second frame portion is capable of being lifted from the vertically shiftable portion of the first frame.

4. A method for supporting a load to be removed from an in-use location, the method comprising the steps of:
providing an apparatus for removing the load;
providing a propelling mechanism associated with the apparatus;
providing at least four wheel assemblies associated with the propelling mechanism;
aligning a vertically shiftable frame portion of the apparatus with the load;
removing the load from the in-use location;
shifting the load onto the frame portion;
lengthening the frame portion to accommodate the load;
spreading the load over a predetermined area on a support surface adjacent the in-use location; and
stabilizing the apparatus as the load is shifted.

5. The method of claim 4 further comprising the step of:
integrating the propelling mechanism with the apparatus.

6. The method of claim 4 further comprising the step of:
maneuvering the apparatus onto the support surface.

7. The method of claim 4 further comprising the step of:
providing a first frame portion and a second frame portion of the apparatus wherein the first frame portion is aligned with the load to be removed and wherein the first frame portion has connections associated with the second frame portion.

8. The method of claim 4 further comprising the step of:
connecting a lifting device to the connections on the first frame portion.

9. The method of claim 4 further comprising the step of:
disconnecting the first frame portion from the second frame portion.

10. The method of claim 4 further comprising the step of:
lifting the first frame portion and the load.

11. A method for supporting and moving a heat exchanger bundle over a transport surface, the method comprising the steps of:
providing a mobile extractor apparatus having a carriage frame and a main frame;
providing a propelling mechanism for moving the apparatus along the transport surface;
raising the main frame and the carriage frame relative to the main frame to the height of the heat exchanger bundle wherein the main frame remains above but generally near the transport surface;
pulling the heat exchanger bundle onto the carriage frame;
lengthening the carriage frame to accommodate the heat exchanger bundle as the heat exchanger bundle is pulled onto the carriage frame;
lowering the carriage frame and the heat exchanger bundle toward the transport surface;
rotating an engaging surface of the propelling mechanism in contact with the transport surface;
transporting the heat exchanger bundle; and
supporting the heat exchanger bundle with the apparatus, the carriage frame, and the main frame while maintaining a surface area of engagement between the engaging surface and the transport surface.

12. The method of claim 12 further comprising the step of:
actuating hydraulic cylinders of the mobile extractor apparatus to raise the main frame and the carriage frame.

13. A method for supporting and moving a heat exchanger bundle along a surface, the method comprising the steps of:
providing a mobile extractor apparatus having a carriage frame, a main frame, and a propelling mechanism;
moving the mobile extractor apparatus along the surface with the propelling mechanism;
raising the main frame and the carriage frame relative to the main frame;
lifting the carriage frame from the main frame to the height of the heat exchanger bundle while the main frame remains above but generally near the surface;
pulling the heat exchanger bundle onto the carriage frame;
lowering the carriage frame and the heat exchanger bundle toward the transport surface;
connecting a lifting device to the carriage frame;
disconnecting the carriage frame from the main frame; and
lifting the carriage frame and the heat exchanger bundle supported by the carriage frame while the main frame and propelling mechanism remain in contact with the engaging surface.

14. The method of claim 13 further comprising the step of:
actuating hydraulic cylinders of the mobile extractor apparatus to lift the main frame and the carriage frame.

15. An apparatus for removing a heat exchanger bundle and transporting the bundle across the surface, the apparatus comprising:
a first frame;
at least four wheel assemblies connected to said first frame;
at least one power source for propelling and controlling steering to at least two of said wheel assemblies;
a second frame and spaced relationship to said first frame;
at least two vertical shiftable columns attachable to said first frame for vertically elevating the first and second frames relative to the surface thereby lifting the wheel assemblies off the surface, and for elevating the second frame relative to the first frame;
said second frame includes a horizontally shiftable frame portion for supporting the heat exchanger;
horizontally shiftable mechanism to move the horizontally shiftable portion relative to the second frame; and
a sled supported by said horizontally shiftable frame and displaced relative to said horizontally shiftable frame,
wherein said sled engages said heat exchanger, said horizontally shiftable frame supports said heat exchanger, and said horizontally shiftable mechanism moves the horizontally shiftable portion relative to the second frame as said heat exchanger moves relative to said first frame.
